(19) United States
(12) Patent Application Publication
(10) Pub. No.: US 2002/0158005 A1
(43) Pub. Date: Oct. 31, 2002

(54) Self-cleaning fluid strainer using nozzle/diffuser for discharge expulsion

(76) Inventor: David A. Laing, Elyria, OH (US)

Correspondence Address: CAESAR, RIVISE, BERNSTEIN,, COHEN & POKOTILOW, LTD., 12TH FLOOR, SEVEN PENN CENTER, 1635 MARKET STREET, PHILADELPHIA, PA, 19103-2212, US

(21) Appl. No.: 09/844,620

(22) Filed: Apr. 27, 2001

(51) Int. Cl. B01D 21/18

(52) U.S. Cl. 210/408

(57) ABSTRACT

An apparatus and method for removing debris suspended in a main fluid flow using a fluid strainer that uses an integrated nozzle/diffuser for discharging debris that is dislodged from an internal porous surface.

### BACKGROUND OF THE INVENTION

This invention relates generally to improved fluid strainers and, more particularly, to fluid strainers for fluid flows whereby debris that is dislodged from the strainer is forceably ejected toward a drain using a high speed fluid flow.

Industrial strainer devices are well-known in the art for use in removing solid debris from in-line fluid flow conditions. One common type of industrial strainer is a so-called basket type which is physically disposed in a fluid line which supplies raw water to a fluid apparatus, such as a fire main pipeline. However, basket type strainers require the basket and the contents thereof to be removed. Such removal requires several hours of labor to clean. Just as significantly, the fluid system is not operational when the basket strainer is removed. Such down time presents, of course, added significant commercial drawbacks.

A significant improvement over such approaches is a fluid strainer apparatus, such as the type described in U.S. Pat. No. 3,278,038 (Acker). These strainers are constructed and operated so as to be in the main fluid flow and facilitate removal of solid particles in the liquid flowing through pipelines by straining the liquid and subsequently scraping the particles from the screen and flushing to remove debris build-up on the strainer. Specifically, these strainers employ a peripheral in-flow strainer or screen, whereby solids are collected on an exterior surface of a perforated rotatable screen. A stationary scraper blade (e.g., see also U.S. Pat. Nos. 148,557 (Gillespie et al.); 556,725 (Farwell); 740,574 (Kohlmeyer) and 793,720 (Godbe)) is positioned adjacent the rotatable screen so as to remove solids from the exterior screen surface when the screen surface is rotated. For effecting cleaning, such screens are rotated by hand or by a motor. Some of the fluid strainer housings include areas which collect and hold the solids removed from the screen for subsequent removal from a waste discharge port during a flushing operation.

While the foregoing fluid strainer should provide significant advantages, there are shortcomings that impact its performance. For example, scraper blades are meant to have certain clearances between the blades' scraping edge and the exterior surface of the rotating screen, however, there is no way to verify these clearances once the blades are installed. In addition, these fluid strainers have not been provided with any method for allowing inspection and adjustment of the scraping blade's clearance, as well as allowing removal of objects which are difficult to scrape, such as leaves and the like.

Moreover, it is commercially desirable to provide a strainer apparatus which is easily convertible from a manual mode of operation to a motorized mode of operation. Successful approaches exist for achieving such conversion, such as the approach utilized with the HELLAN® fluid strainers that which are available from Hellan Strainer, Cleveland, Ohio, USA. These last noted type strainers achieve conversion by removing the entire manual handwheel assembly which includes the handwheel, the handwheel's journal housing, the hand wheel drive shaft, as well as the rotatable screen and replacing them by a motorized drive system which includes a rotatable screen, a screen drive shaft, and a shaft journal housing.

An improvement to these replaceable rotatable screen designs is disclosed in U.S. Patent No. RE35,560 (Simonelli et al.). The Simonelli et al. patent discloses a fluid strainer that comprises a pair of cylindrical strainers which can be moved during cleaning either manually or automatically. The fluid strainer includes a gear motor housing for facilitating the conversion between either manual or automatic mode. The strainer also includes an inspection means and a removal means.

Once the particulates or debris are dislodged from the filter surface, it is necessary to divert these contaminants toward a drain to dispose of such debris and to prevent such debris from re-attaching to the filter. One solution is to isolate the dislodged particulates between a pair of confining walls. For example, the use of a brush, or high speed cleaning spray, disposed between a pair of walls for cleaning a cylindrical filter is known in the art, as is disclosed in U.S. Pat. Nos. 5,423,977 (Aoki et al.) and 5,595,655 (Steiner et al.) and Swiss Patent No. 22,863 (Zingg). Another variation employs a backwash that drives the particulate contaminants off of the cylindrical filter, as is disclosed in U.S. Pat. No. 3,338,416 (Barry). In U.S. Pat. No. 6,177,022 (Benenson, Jr. et al.), a partition with apertures is used in combination with the confining walls along with a brush, or scraper to dislodge particulates and divert them toward a drain while minimizing the chances of such particulates re-attaching to the filter.

An improved method for diverting such dislodged debris utilizes an external eductor, i.e., jet pump, for driving the dislodged debris into a drain. In particular, FIG. 1 depicts an existing filter strainer apparatus 10, supplied by Cleveland Gear of Cleveland, Ohio, wherein an eductor 18 (e.g., a 3″ LL eductor supplied by Penberthy, Inc. of Prophetstown, Ill.) is coupled to the main fluid flow. In particular, a fluid strainer apparatus 12 comprises an inlet port 14 that is adapted to be coupled to an inlet pipe (not shown) which provides a main inlet flow (e.g., 2000 GPM, such as raw sea water) . The fluid strainer apparatus 12 also comprises an outlet port 16 that is adapted to be coupled to an outlet pipe (also not shown) which can supply strained fluid to a downstream application, such as a fire main pipeline. The fluid strainer (not shown) comprises a pair of inclined cylindrical screens that effectively serve to function in-line so as to strain solids suspended in the raw water from entering the outlet pipe. As an example, the size of these cylindrical screens may vary from 3.5″ to 9.125″ in diameter. During normal flow, these cylindrical filters are stationary. In order to initiate a cleaning cycle, either a timer starts the cycle or a pressure switch 19 detects a build-up of pressure at the cylindrical filters. For example, during normal flow where there is no accumulation of debris, the pressure at the cylindrical filters is approximately 1 lb/in²; however, where debris has accumulated, the pressure may rise to 4-5 lb/in². When the pressure switch 19 detects this elevated pressure, it informs a controller (not shown, or if a timed cycle is used, the controller itself initiates the clean cycle at the proper time) which (1) begins turning the cylindrical filters, wherein closely-adjacent scrapers begin dislodging the debris from the filters; (2) opens a motorized valve 20; and (3) supplies pressure to the input side 22 of the external eductor 18. The supply of pressure to the input side 22 of the eductor 18 causes a flow through the outlet side 24 of the eductor 18 toward a drain discharge port (not shown). This flow creates a vacuum in a passageway 26 created by the opening of the motorized valve 20. Thus, dislodged debris is sucked through the passageway 26, through the motorized valve 20, into the body of the eductor 18 and then out toward the drain discharge. The overall time of this eductor 18 activation is approximately 15-30 seconds. After that time, the controller removes the pressure from the eductor 18, closes the motorized valve 20 and stops the filters from rotating. During the cleaning process, only about 150 GPM are diverted through the passageway 26, which is approximately 5% of the main flow.

However, the above fluid strainer apparatus requires the use of an external eductor and plumbing between the main fluid flow, the eductor and the drain. Thus, there is a need for an improved apparatus and method for driving dislodged debris from a main fluid (e.g., water) flow into a drain using an active device that is contained within the fluid strainer apparatus itself.

### SUMMARY OF THE INVENTION

A fluid strainer apparatus adapted to be coupled to a fluid line for removing debris suspended in a fluid (e.g., water) flowing through the fluid line. The strainer apparatus has a housing for passing the fluid flow therein and whereby the housing comprises: at least one porous member (e.g., a cylindrical screen) that is exposed to the fluid flow and wherein the suspended debris is deposited on an upstream side (e.g., the outer surface of the cylindrical screen) of the at least one porous member during the fluid flow; at least one debris remover (e.g., a scraper or brush) disposed closely adjacent the upstream side of the at least one porous member such that when the at least one porous member is displaced (e.g., rotated about a cylindrical axis of the cylindrical screen) the at least one debris remover dislodges the deposited debris off from the upstream side into a space within the housing that comprises low turbulence and low flow; a first lumen (e.g., a nozzle) having a first output end that emits a high velocity flow of fluid toward said space whenever the at least one porous member is displaced and wherein the first lumen has an input end connected to a high pressure source (e.g., a pump) of a fluid; and a second lumen (e.g., a diffuser) having an open input end located opposite the first lumen output end and having a second output end coupled to a drain discharge, and wherein the open input end receives the dislodged debris that is driven out of the space by the high velocity flow of fluid and into the drain discharge.

A method for removing debris suspended in a main fluid (e.g., water) flow. The method comprises the steps of: (a) disposing at least one porous member into the main fluid flow such that the debris is deposited on an upstream side of the at least one porous member (e.g., a cylindrical screen); (b) positioning at least one debris remover (e.g., a scraper or brush) closely adjacent said upstream side(e.g., the outer surface of the cylindrical screen) of the at least one porous member; (c) displacing (e.g., rotating the cylindrical screen) the at least one porous member such that the at least one debris remover dislodges the deposited debris off from the upstream side towards a location of low turbulence and low velocity; and (d) directing a high velocity stream of fluid at the dislodged debris at the location to drive the dislodged debris into an open end of a lumen positioned opposite of the high velocity stream of fluid and wherein the lumen comprises an output end coupled to a drain discharge for passing the driven dislodged debris into the drain discharge.

### DESCRIPTION OF THE DRAWINGS

Many of the intended advantages of this invention will be readily appreciated when the same becomes better understood by reference to the following detailed description when considered in connection with the accompanying drawings wherein:

FIG. 1 is a side elevation view of an existing fluid strainer that utilizes an external eductor;

FIG. 2 is a side elevation view of the fluid strainer apparatus of the present invention;

FIG. 3 is a diagrammatic, broken-away isometric view of the fluid strainer apparatus of the present invention showing cylindrical screens that are rotated during cleaning while a main flow is passing through the apparatus;

FIG. 4 is a cross-sectional view of the filter strainer apparatus housing taken along line 4-4 of FIG. 2;

FIG. 5 is a cross sectional view of the filter strainer apparatus taken along line 5-5 of FIG. 4;

FIG. 6 is a vertical partial cross-sectional view of the scraper and cylindrical screen taken along line 6-6 of FIG. 4; and

FIG. 7 is a horizontal partial cross-sectional view of the scraper support taken along line 7-7 of FIG. 4.

### DETAILED DESCRIPTION OF THE PREFERRED EMBODIMENTS

Referring now in greater detail to the various figures of the drawing, wherein like reference characters refer to like parts, there is shown in FIG. 1 at 110 a filter strainer apparatus of the present invention. As will be discussed in detail later, the filter strainer apparatus 110 utilizes an integrated nozzle and diffuser for diverting dislodged debris into a drain discharge.

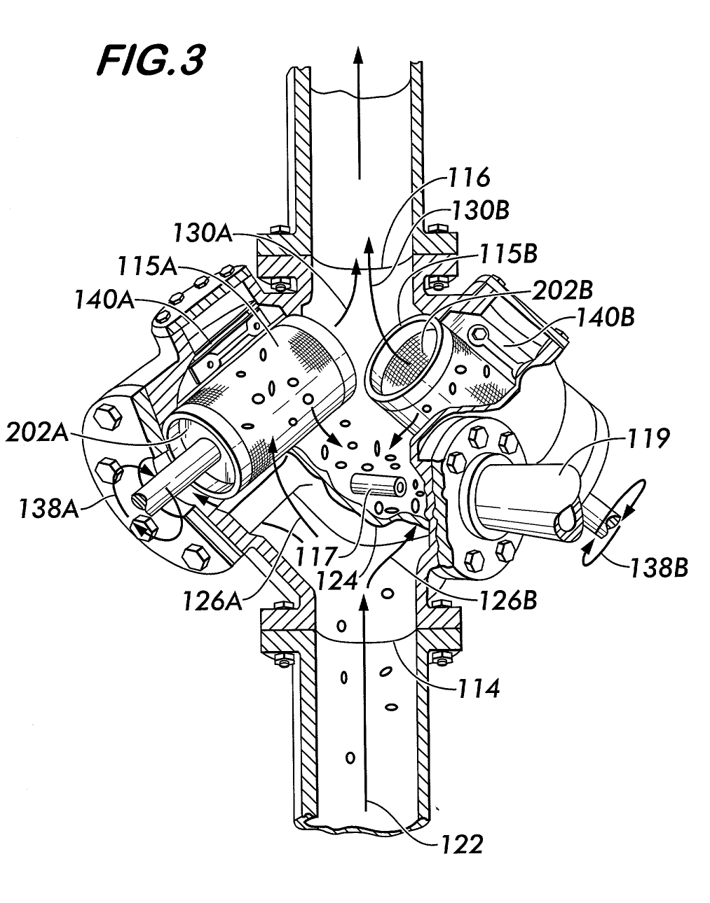

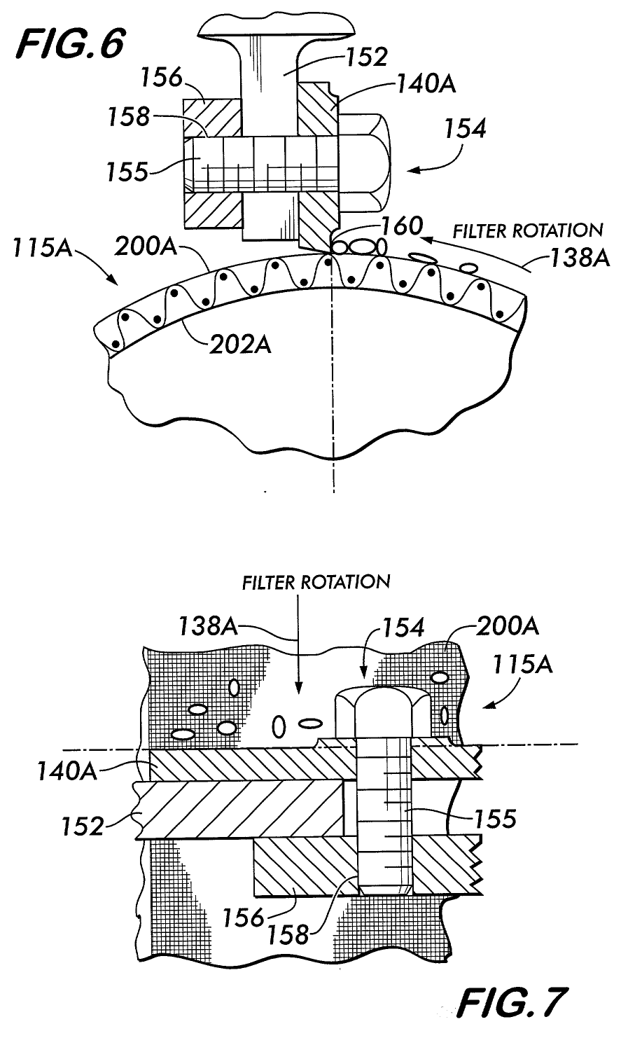

The filter strainer apparatus 110 comprises a housing 112 having an inlet port 114 and an outlet port 116 for passing a main fluid (e.g., water) flow (indicated by the arrow 122 in FIG. 3) therethrough. As will also be discussed in detail later, the housing 112 includes at least one porous member (e.g., a cylindrical screen 115A or 115B-see FIG. 3) that is exposed to this main fluid flow whereby suspended debris in the main fluid flow is deposited on an upstream side of the at least one porous member. At least one debris remover (e.g., a brush or scraper 140A-see FIG. 6) is located closely adjacent this upstream side wherein when the at least one porous member is to be cleaned, the at least one porous member is displaced (e.g., rotated) so that the debris remover dislodges the deposited debris from the upstream side. Once dislodged, the debris is driven by the output of a nozzle 117 into a diffuser 119 which is coupled to a drain discharge. Thus, it should be understood that it is within the broadest scope of this invention to include any number of porous members and debris removers, e.g., one cylindrical screen and one scraper, or a plurality of cylindrical screens and a plurality of scrapers, and that the present invention is not in any way limited to the number of porous members/debris removers shown.

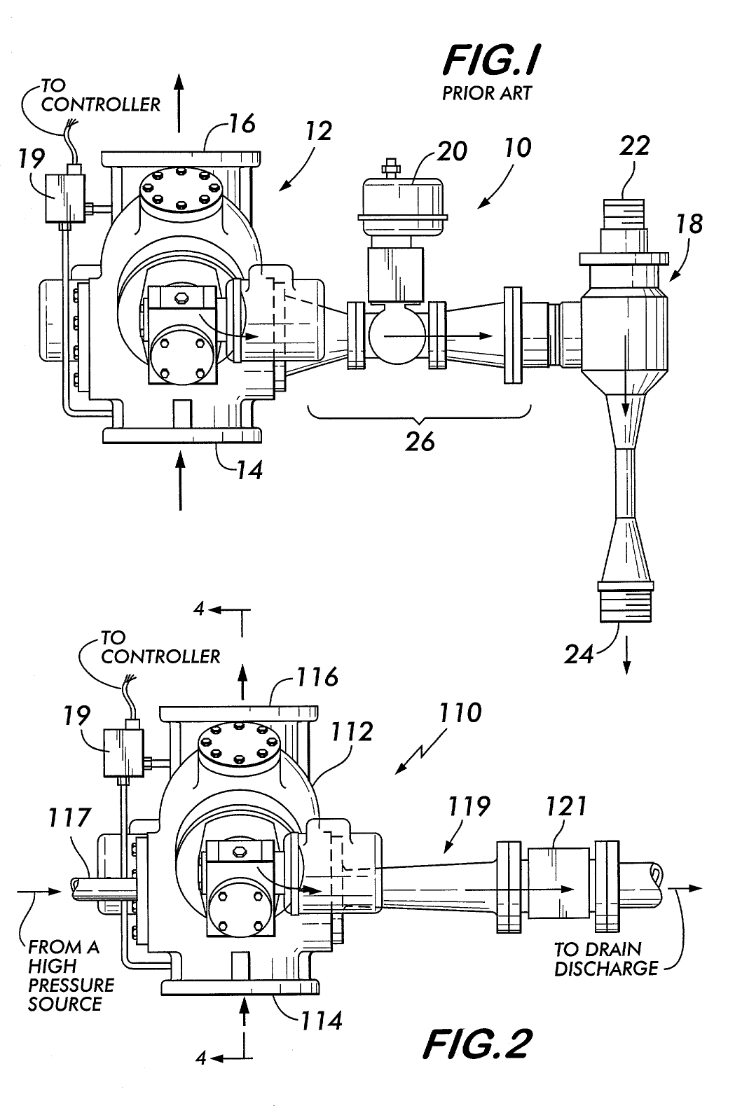

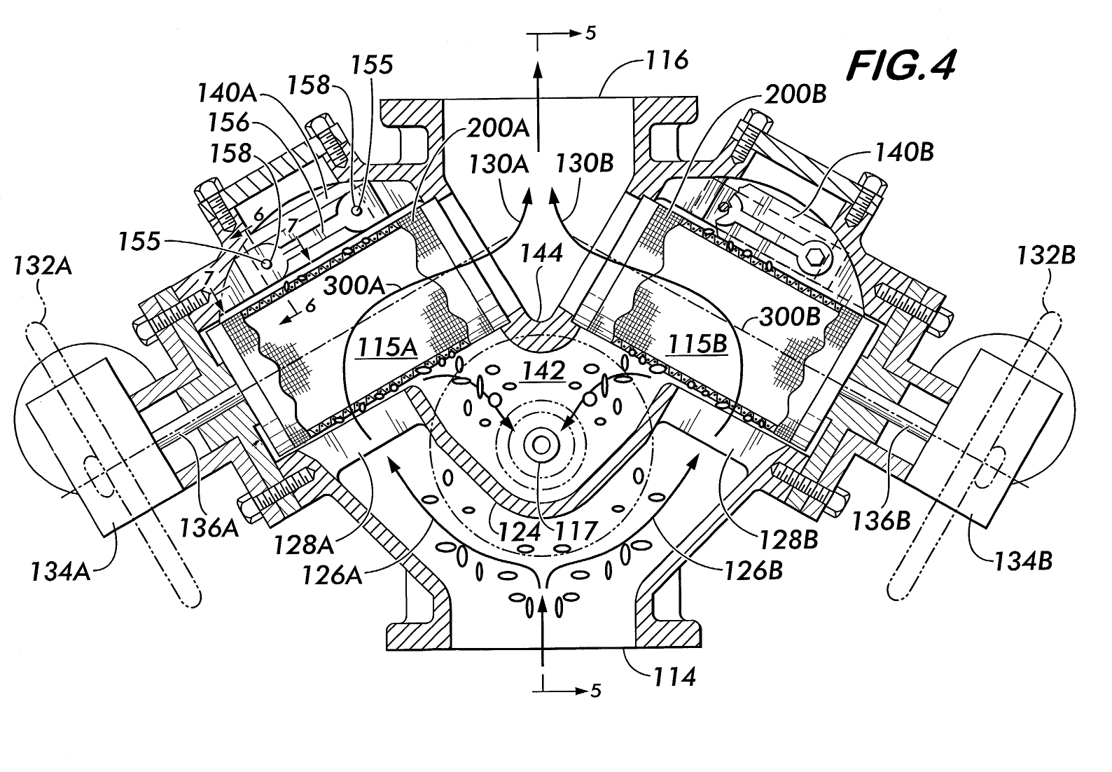

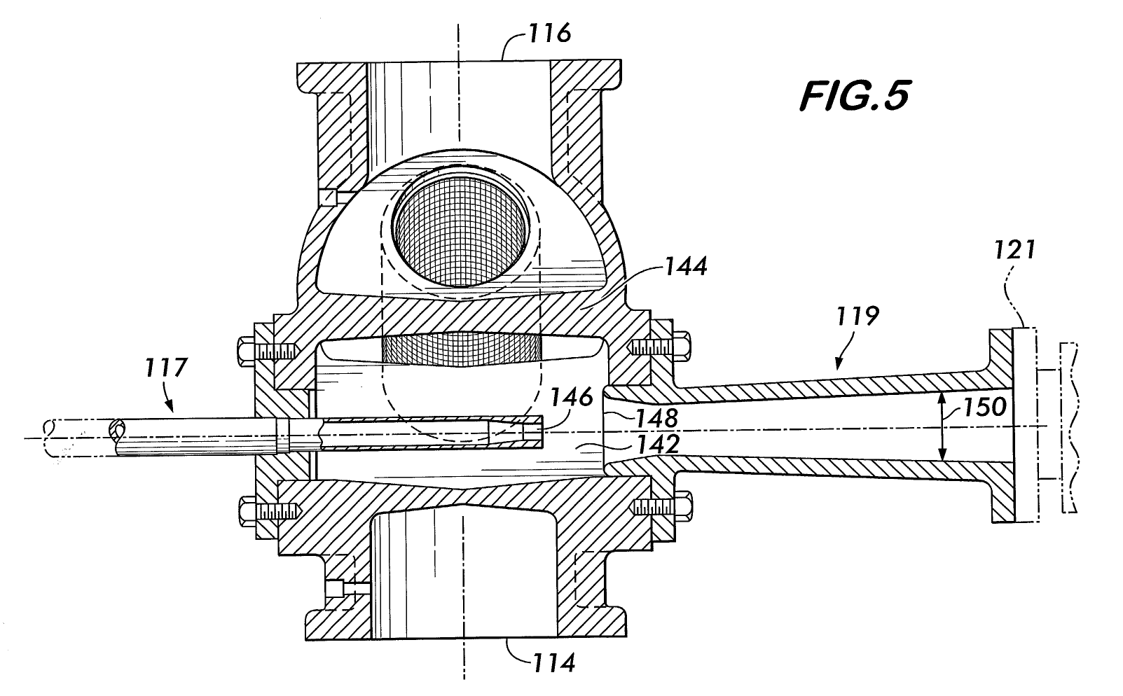

In a preferred embodiment of the present invention, as shown in FIGS. 2-7, the at least one porous member is implemented using a pair of cylindrical screens 115A/115B (FIG. 3). In particular, the housing 112 comprises an angled surface, e.g. a baffle 124 (FIG. 4) located after the input port 114 and upstream of the pair of cylindrical screens 115A/115B. This angled surface divides the main fluid flow into a first and second subflow, indicated by respective arrows 126A and 126B, which are directed towards a corresponding cylindrical screen 115A or 115B. As a result, it is on the outside surface 200A/200B (FIG. 4) of these cylindrical screens 115A/115B that the suspended debris is deposited. The cleaned subflows, indicated by respective arrows 130A and 130B, then pass through the interior of the cylindrical screens 115A/115B. These two subflows then re-combine and exit out of the outlet port 116.

By way of example only, the size of the cylindrical screens 115A/115B may vary from 3.5″ to 9.125″ in diameter but are not limited to those dimensions. In addition, these cylindrical screens are rotatably mounted along respective cylindrical axes 300A/300B inside the main housing 112 for serving as in-line screens for straining out the debris suspended in the main fluid flow. The size of the screen perforations and the material of the screens can vary depending upon the intended use and do not form an aspect of the present invention.

As shown most clearly in FIG. 3, the input flow, as indicated by the arrow 122, enters the housing 112 through the inlet port 114 where it encounters the baffle 124 that divides the input flow having debris therein into the first subflow (indicated by the arrow 126A) towards the first cylindrical screen 115A and into the second subflow (indicated by the arrow 126B) towards the second cylindrical filter 115B; FIG. 4 provides a more clear view of the baffle 124. During normal operation, the cylindrical screens 115A/115B are stationary and the respective subflows 126A/126B move toward the outside surfaces 200A/200B of the cylindrical screens 115A/115B. Each flow 126A/126B encounters a respective barrier bar 128A/128B (FIG. 4) for breaking large debris into small pieces, over and under which the subflows continue toward the respective cylindrical screen. These small pieces then impact and are deposited on the outside surface 200A/200B of the respective cylindrical screen 115A/115B. The respective cleaned flows (indicated by the arrows 130A/130B) pass through the outer surface 200A/200B of the screens 115A/115B and into the hollow center of the screens 115A/115B. Because of the pressure differential between the input port 114 and the output port 116, the respective clean flows 130A/130B then re-combine and exit through the outlet port 116.

To clean the debris off of the outer surface of the cylindrical screens 115A/115B, the screens 115A/115B are rotated (either manually or automatically; if they are rotated manually, a respective drive wheel 132A/132B is manually rotated by an operator; alternatively, if they are rotated automatically, a respective motor 134A/134B is energized by a controller (not shown)) via a respective central shaft 136A/136B of each cylindrical screen 115A/115B; the direction of rotation is indicated by the arrows 138A/138B in FIG. 3. During this rotation, a brush or scraper 140A/140B which is located closely adjacent the outer surface 200A/200B of each cylindrical screen 115A/115B dislodges the debris deposited on the outer surface 200A/200B of the screens 115A/115B. As the screens 115A/115B are rotated, the dislodged debris is contained within a cavity 142 (most clearly shown in FIG. 4) formed on the top by the screens 115A/115B themselves and an upper screen support member 144 and on the bottom by the baffle 124. This cavity 142 is a zone or space of low velocity, low turbulence flow to where the dislodged debris can migrate that is out of the way of the main fluid flow.

Simultaneously, while these cylindrical screens 115A/115B are being rotated, the nozzle 117 (e.g, a 1″ diameter pipe) is provided with a clean fluid from a high pressure source (e.g., a pump, not shown) that passes through the nozzle head 146 (e.g., a tapered tip, ¾″ diameter) at a high velocity. By way of example only, if the high pressure source operates at 50 psi, the high velocity output of the nozzle 117 is approximately 80 ft/sec. Since the nozzle head 146 is located within the cavity 142, the dislodged debris is driven into the opening 148 of the diffuser 119 and towards a valve mechanism 121. The valve mechanism 121 may simply comprise a ball valve that is either opened by the controller or is manually opened by an operator during the cleaning cycle. Once opened, the flow from the diffuser 119 can pass into the drain discharge. Thus, the ball valve prevents the loss of fluid into the drain discharge when the cleaning cycle is not occurring and also prevents the inflow of air from the drain discharge. Furthermore, the valve mechanism 121 may further comprise a swing check valve (e.g., a 50-SC swing check valve manufactured by American Cast Iron Pipe Company of Birmingham, Ala.) coupled to the ball valve output and that is opened by the flow through the diffuser 119 on the way to the drain discharge and is biased to close rapidly once the flow through the diffuser 119 is minimal. The presence of the swing check valve prevents the possible momentary entrance of air that may be in the drain line when the ball valve is first opened. The swing check valve requires no control by the controller or an operator.

Once the debris is driven into the diffuser 119, the diffuser 119 slows the flow down as can be seen by the widening diameter 150 of the diffuser body, which reduces or “diffuses” the speed of the ejected debris flow, hence the term “diffuser”. While the nozzle 117 is operating, the controller (or operator) has opened the ball valve of the valve mechanism 121, thereby allowing the debris to pass therethrough and then into the drain discharge. When the cleaning cycle is complete, the controller (or operator) closes the ball valve of valve mechanism 121 to prevent the loss of fluid into the drain and also to prevent the inflow of air from the drain discharge.

Where the cleaning cycle is automated, the controller can initiate the cleaning cycle on a time basis or it is based on a sensor input. For example, the pressure switch 19 mentioned earlier can also be used (see FIG. 2) whereby if a threshold pressure (e.g., 4-5 lb/in²) is detected at the cylindrical filters 115A/115B, the pressure switch 19 informs the controller which commands the motors 134A/134B to begin rotating the screens 115A/115B. The cleaning cycle may take approximately 15-30 seconds and during that time approximately 5% of the main fluid flow input actually passes to the drain discharge.

As mentioned earlier, a brush/scraper 140A/140B dislodges the debris from the outer surface 200A/200B of the cylindrical screens 115A/115B. FIGS. 6-7 depict one of the brush/scrapers, namely brush/scraper 140A and its corresponding support, it being understood that the brush/scraper 140B uses a similar support arrangement. In particular, the brush/scraper 140A is releasably secured to a flange casting 152, which is part of the housing 112 using a fastener (e.g., threaded bolt) 154 and a capture member (e.g. a strap) 156. The fastener 154 has a shank 155 and a head 157. The head 157 of the fastener 154 presses against the brush/scraper 140A while the lower end of the shank 155 is captured in a hole 158 in the capture member 156. As shown most clearly in FIG. 4, the capture member 156 comprises two holes 158 and the respective shanks 155 of the fasteners 154. When the fasteners 154 are secured accordingly, the brush/scraper 140A has an edge 160 (FIG. 6) that is closely adjacent the outer surface 200A of the cylindrical screen 115A for dislodging debris deposited on the outer surface 200A.

It should be understood that the clean fluid provided from the high pressure source may include cleaned downstream fluid from the combined subflows 130A/130B that is passed through a pump to generate the high pressure. Alternatively, the fluid could be an external source of fluid, e.g., seawater, if the device 110 is mounted on a sea vessel. Thus, it is within the broadest scope of the present invention to include any type of fluid for generating the high velocity fluid emitted by the nozzle 117.

Without further elaboration, the foregoing will so fully illustrate my invention and others may, by applying current or future knowledge, readily adapt the same for use under various conditions of service.

I claim:

1. A fluid strainer apparatus adapted to be coupled to a fluid line for removing debris suspended in a fluid flowing through the fluid line, said strainer apparatus having a housing for passing the fluid flow therein, said housing comprising:
at least one porous member that is exposed to the fluid flow and wherein the suspended debris is deposited on an upstream side of said at least one porous member during the fluid flow;
at least one debris remover disposed closely adjacent said upstream side of said at least one porous member such that when said at least one porous member is displaced said at least one debris remover dislodges the deposited debris off from said upstream side into a space within said housing that comprises low turbulence and low flow;
a first lumen having a first output end that emits a high velocity flow of fluid toward said space whenever said at least one porous member is displaced, said first lumen having an input end connected to a high pressure source of a fluid; and
a second lumen having an open input end located opposite said first lumen output end and having a second output end coupled to a drain discharge, said open input end receiving the dislodged debris that is driven out of said space by said high velocity flow of fluid and into the drain discharge.

2. The apparatus of claim 1 wherein said first lumen comprises a nozzle and wherein said first output end comprises a tapered passageway.

3. The apparatus of claim 1 wherein said second lumen comprises a tapered body wherein said second output end comprises a diameter that is larger than a diameter of said open input end.

4. The apparatus of claim 1 wherein said at least one porous member comprises a cylindrical screen wherein said upstream side comprises the outer surface of said cylindrical screen.

5. The apparatus of claim 4 wherein said cylindrical screen is displaced by being rotated about a cylindrical axis of said cylindrical screen.

6. The apparatus of claim 5 wherein said at least one debris remover comprises a scraper having an edge that is closely adjacent said outer surface.

7. The apparatus of claim 1 wherein said second output end is coupled to the drain discharge via a swing check valve.

8. The apparatus of claim 1 further comprising an angled surface located upstream of said upstream side of said porous member for dividing the fluid flow into a first subflow and a second subflow.

9. The apparatus of claim 8 wherein said at least one porous member comprises a first porous member that is exposed to said first subflow and a second porous member that is exposed to said second subflow.

10. The apparatus of claim 9 wherein said first and second porous members comprise first and second cylindrical screens each having an outer surface that forms said upstream side of said at least one porous member.

11. The apparatus of claim 10 wherein said first and second cylindrical screens are displaced by being rotated about a respective cylindrical axis of said cylindrical screens.

12. The apparatus of claim 11 wherein said at least one debris remover comprises a first scraper for said first cylindrical screen and a second scraper for said second cylindrical screen and wherein each of said scrapers comprises a respective edge that is closely adjacent a corresponding outer surface of said first and second cylindrical screens.

13. The apparatus of claim 12 wherein said first lumen comprises a nozzle and wherein said output end comprises a tapered passageway.

14. The apparatus of claim 12 wherein said second lumen comprises a tapered body wherein said output end comprises a diameter that is larger than a diameter of said open input end.

15. The apparatus of claim 12 wherein said second output end is coupled to the drain discharge via a swing check valve.

16. The apparatus of claim 11 wherein said space comprising low turbulence and low flow comprises a cavity in said housing formed by an upper support member that supports the top end of said first and second cylindrical screens, said first and second screens and said angled surface.

17. A method for removing debris suspended in a main fluid flow, said method comprising the steps of:
(a) disposing at least one porous member into the main fluid flow such that the debris is deposited on an upstream side of said at least one porous member;
(b) positioning at least one debris remover closely adjacent said upstream side of said at least one porous member;
(c) displacing said at least one porous member such that said at least one debris remover dislodges the deposited debris off from said upstream side towards a location of low turbulence and low velocity; and
(d) directing a high velocity stream of fluid at the dislodged debris at said location to drive the dislodged debris into an open end of a lumen positioned opposite of said high velocity stream of fluid and wherein said lumen comprises an output end coupled to a drain discharge for passing said driven dislodged debris into said drain discharge.

18. The method of claim 17 wherein said step of disposing at least one porous member into the main fluid flow comprises disposing a cylindrical screen into the main fluid flow wherein said upstream side comprises the outside surface of said cylindrical screen.

19. The method of claim 18 wherein said step of displacing said at least one porous member comprises rotating said cylindrical screen about a cylindrical axis.

20. The method of claim 19 wherein said step of positioning at least one debris remover closely adjacent said upstream surface comprises positioning a scraper having an edge closely adjacent said outer surface.

21. The method of claim 17 wherein said step of disposing at least one porous member into the main fluid flow comprises:
(a) positioning an angled surface, located upstream of said upstream side of said at least one porous surface, to divide the main input flow into a first subflow and a second subflow; and
(b) disposing a respective cylindrical screen into said first and second subflows wherein said upstream side comprises the outside surfaces of said cylindrical screens.

22. The method of claim 21 wherein said step of displacing said at least one porous member comprises rotating said cylindrical screens about a respective cylindrical axis.

23. The method of claim 22 wherein said step of positioning at least one debris remover closely adjacent said upstream side of said at least one porous member comprises positioning an edge of a first scraper closely adjacent said outer surface of said first cylindrical screen and positioning an edge of a second scraper closely adjacent said outer surface of said second cylindrical screen.

24. The method of claim 17 further comprising the step of positioning a swing check valve between said output end of said lumen and the drain discharge, said swing check valve being opened when said high velocity stream of fluid is present and said swing check valve being closed when said high velocity stream of fluid is not present.
